(19) United States
(12) Patent Application Publication
(10) Pub. No.: US 2025/0386104 A1
(43) Pub. Date: Dec. 18, 2025

(54) SOLID-STATE IMAGING DEVICE AND IMAGING SYSTEM

(71) Applicant: SAMSUNG ELECTRONICS CO., LTD., Suwon-si (KR)

(72) Inventor: Yoshiharu KUDO, Yokohama (JP)

(73) Assignee: SAMSUNG ELECTRONICS CO., LTD., Suwon-si (KR)

(21) Appl. No.: 19/235,933

(22) Filed: Jun. 12, 2025

(30) Foreign Application Priority Data
Jun. 12, 2024 (JP) 2024-094987
Mar. 6, 2025 (KR) 10-2025-0029270

(51) Int. Cl. H04N 23/76; H04N 23/71; H04N 23/81; H04N 25/77

(52) U.S. Cl. CPC H04N 23/76; H04N 23/71; H04N 25/77; H04N 23/81

(57) ABSTRACT

A solid-state imaging device includes: a plurality of pixels, wherein each pixel of the plurality of pixels includes: a photoelectric converter configured to detect photons and to output a signal corresponding to a number of photons that are detected; and at least one operation processor configured to add an output signal of the photoelectric converter for pulsed light and external light which are received by the pixel in a first period in one frame period, and to subtract the output signal of the photoelectric converter for the external light received by the pixel in a second period in the one frame period.

### CROSS-REFERENCE TO RELATED APPLICATION

This application claims priority to Japanese Patent Application No. 2024-094987, filed on Jun. 12, 2024, in the Japanese Patent Office, and Korean Patent Application No. 10-2025-0029270, filed on Mar. 6, 2025, in the Korean Intellectual Property Office, the disclosure of which is incorporated by reference herein in its entirety.

### BACKGROUND

The present disclosure relates to a solid-state imaging device and an imaging system.

Near-infrared image sensors are used in driver monitoring systems that perform facial recognition of drivers in automobiles.

As a technology related to the solid-state imaging device and the imaging system, an image processing device may be proposed from the viewpoint of suppressing the influence of background light on a captured image. The image processing device may generate a first infrared radiation (IR) image captured with a pulse wave turned on, and a second IR image captured with the pulse wave turned off, and may correct the first IR image based on the second IR image. According to such a configuration, the influence of background light may be removed by subtracting the second IR image from the first IR image. However, due to a large time difference between the two IR images in the image processing device, there is a problem that artifacts may occur at the edge of a subject (for example, a driver) when the subject moves during capturing.

### SUMMARY

Provided are a solid-state imaging device and an imaging system that may suppress occurrence of an artifact in a captured image and remove the influence of background light.

According to an aspect of the disclosure, a solid-state imaging device includes: a plurality of pixels, wherein each pixel of the plurality of pixels includes: a photoelectric converter configured to detect photons and to output a signal corresponding to a number of photons that are detected; and at least one operation processor configured to add an output signal of the photoelectric converter for pulsed light and external light which are received by the pixel in a first period in one frame period, and to subtract the output signal of the photoelectric converter for the external light received by the pixel in a second period in the one frame period.

According to an aspect of the disclosure, an imaging system includes: a light source device configured to radiate pulsed light to a subject; and a solid-state imaging device configured to receive the pulsed light reflected by the subject, wherein the solid-state imaging device includes a plurality of pixels, and wherein each pixel of the plurality of pixels includes: a photoelectric converter configured to detect photons and to output a signal corresponding to a number of photons that are detected; and at least one operation processor configured to add an output signal of the photoelectric converter for the pulsed light and external light which are received by the pixel in a first period in one frame period, and to subtract the output signal of the photoelectric converter for the external light received by the pixel in a second period in the one frame period.

According to an aspect of the disclosure, a solid-state imaging device includes a plurality of pixels, wherein each of the plurality of pixels includes: a photoelectric converter configured to detect photons and to output a pulse signal corresponding to the photons that are detected; a first operation processor, a second operation processor, a third operation processor, and a fourth operation processor; and a first switch, a second switch, a third switch, and a fourth switch which are configured to connect the first operation processor, the second operation processor, the third operation processor, and the fourth operation processor, respectively, to the photoelectric converter, and wherein each of the first operation processor, the second operation processor, the third operation processor, and the fourth operation processor is configured to up-count the pulse signal output from the photoelectric converter in a first period in one frame period and down-count the pulse signal output from the photoelectric converter in a second period in the one frame period.

### BRIEF DESCRIPTION OF THE DRAWINGS

The above and/or other aspects will be more clearly understood from the following detailed description taken in conjunction with the accompanying drawings, in which:

FIG. 1 is a diagram illustrating a schematic configuration of an imaging system according to an embodiment;

FIG. 2 is a circuit diagram illustrating a schematic configuration of a pixel of according to an embodiment;

FIG. 3 is a timing diagram illustrating an example of an operation of an imaging system according to an embodiment;

FIG. 4 is a circuit diagram illustrating a schematic configuration of a pixel of according to an embodiment; and

FIG. 5 is a timing diagram illustrating an example of an operation of an imaging system according to an embodiment.

### DETAILED DESCRIPTION

Hereinafter, embodiments of the disclosure will be described in detail with reference to the accompanying drawings. In the following drawings, the same reference numerals denote the same components, and the size of each component in the drawings may be exaggerated for clarity and convenience of description. Meanwhile, the embodiments described below are merely exemplary, and various modifications are possible from the above embodiments.

The term “on” below includes not only being directly above in contact, but also being above in a non-contact manner. Likewise, the term “under” below includes not only being directly below in contact, but also being below in a non-contact manner.

A singular expression includes a plural expression unless the context clearly indicates that it is singular. In addition, when a part is said to “include” or “have” a component, this does not exclude other components, unless otherwise specifically stated, but rather implies that other components may be included.

The steps that make up a method are explicitly described in an order, or, unless otherwise stated, the steps are performed in the appropriate order. It is not necessarily limited to the order in which the above steps are described. Any use of examples or exemplary terms is for the purpose of illustrating technical ideas only and does not limit the scope of the claims, unless otherwise limited by the claims, by such examples or exemplary terms.

In addition, in the following description, when ordinal numbers such as “first” and “second” are used for explanation, unless specifically stated otherwise, they are used for convenience and do not stipulate any order.

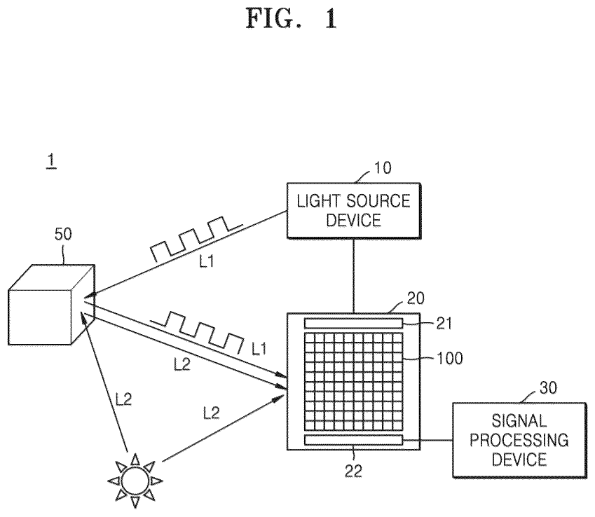

FIG. 1 is a diagram illustrating a schematic configuration of an imaging system 1 according to an embodiment. The imaging system 1 may be used in an environment in which external light such as sunlight is present.

As shown in FIG. 1, the imaging system 1 includes a light source device 10, a solid-state imaging device 20, and a signal processing device 30. The light source device 10, the solid-state imaging device 20, and the signal processing device 30 may be electrically connected to one another.

The light source device 10 irradiates a subject 50 with pulsed light L1. The light source device 10, for example, a semiconductor laser irradiates the subject 50 with the pulsed light L1 in a near-infrared wavelength band. The light source device 10 irradiates the subject 50 with the pulsed light L1 flashing at a predetermined frequency, for example, 1 kHz to 10 kHz. The light source device 10 may include an optical element.

The solid-state imaging device 20 receives the pulsed light L1 reflected by the subject 50. In addition, the solid-state imaging device 20 receives external light L2 such as sunlight. The solid-state imaging device 20 includes a plurality of pixels 100 arranged in a pixel array. Each pixel 100 includes a single photon avalanche diode (SPAD) capable of detecting a single photon. Each of the pixels 100 is controlled by a driving circuit 21, and a value of each of the pixels 100 is output to the outside by a signal output circuit 22 as a pixel signal. The solid-state imaging device 20 may also include an optical element.

The signal processing device 30 performs various processings on the pixel signal output from the solid-state imaging device 20. The signal processing device 30 generates a captured image of the subject 50 from the pixel signal output from the solid-state imaging device 20.

In addition, the imaging system 1 may include components other than the components described above according to an embodiment, and may not include some of the components described above according to an embodiment. For example, the signal processing device 30 may be provided in the solid-state imaging device 20 as a signal processing circuit according to an embodiment.

The solid-state imaging device 20 and the imaging system 1 according to an embodiment of the disclosure may prevent artifacts from occurring in the captured image and may remove the influence of background light by performing processing for removing the influence of external light (background light) at a time interval that is shorter than time for generating the captured image.

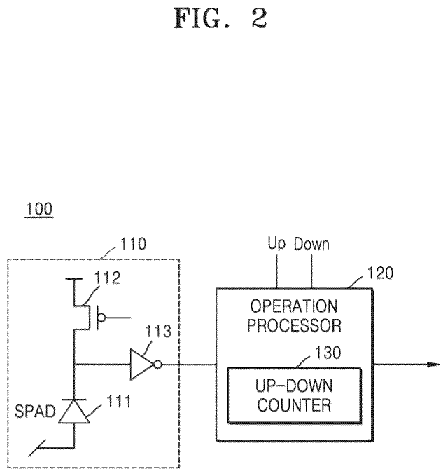

The pixel 100 of the solid-state imaging device 20 will be described with reference to FIG. 2 described below.

FIG. 2 is a circuit diagram illustrating a schematic configuration of a pixel 100 according to an embodiment. As illustrated in FIG. 2, the pixel 100 includes a photoelectric conversion unit or photoelectric converter 110 and an operation processing unit or operation processor 120.

The photoelectric converter 110 includes an SPAD 111, a transistor 112, and an inverter 113. The SPAD 111 detects photons, and the photoelectric converter 110 outputs a pulse signal corresponding to a number of photons detected by the SPAD 111.

A cathode of the SPAD 111 is connected to a drain of the transistor 112, and an anode of the SPAD 111 is connected to a negative voltage source. A source of the transistor 112 is connected to a constant voltage source. The anode of the SPAD 111 and the source of the transistor 112 (i.e., a node between the SPAD 111 and the transistor 112) are also connected to an input terminal of the inverter 113. An output terminal of the inverter 113 is connected to the operation processor 120. The inverter 113 may convert an analog signal supplied from the SPAD 111 into a pulse signal. At this time, because the configuration of the photoelectric converter 110 is a well-known configuration, a detailed description of the configuration of the photoelectric converter 110 is omitted.

The photoelectric converter 110 according to the present embodiment detects photons of the pulsed light L1 and the external light L2 which are received by the pixel 100 based on the SPAD 111, and outputs the number of pulse signals corresponding to the number of photons detected by the SPAD 111. Specifically, in a first period in which the pulsed light L1 is turned on during a flashing cycle of the pulsed light L1, the photoelectric converter 110 detects photons for the pulsed light L1 and the external light L2 and outputs pulse signals of a number corresponding to the number of detected photons. In a second period in which the pulsed light L1 is turned off during the flashing cycle of the pulsed light L1, the photoelectric converter 110 detects photons for the external light L2 and outputs pulse signals of a number corresponding to the number of detected photons. The number of pulse signals represents an amount (intensity) of light received by the pixel 100 in the first or second period.

The operation processor 120 includes an up-down counter 130 up-counting or down-counting a pulse signal. The operation processor 120 up-counts the pulse signal output from the photoelectric converter 110 in the first period in which the pulsed light L1 is turned on, and down-counts the pulse signal output from the photoelectric converter 110 in the second period in which the pulsed light L1 is turned off. In other words, the operation processor 120 up-counts the pulse signal in a period in which the pixel 100 receives the pulsed light L1 and the external light L2, and down-counts the pulse signal in a period in which the pixel 100 receives only the external light L2. According to such a configuration, by subtracting a count value representing an amount of light including only an external light component from a count value representing an amount of light including both a pulsed light component and the external light component, a count value representing an amount of light including only the pulsed light component may be obtained.

The operation processor 120 of the present embodiment performs processing for up-counting the pulse signal and processing for down-counting the pulse signal for each flashing cycle of the pulsed light L1 in a period in which pulsed light L1 is continuously radiated from the light source device 10 to the subject 50. A final count value of the operation processor 120 is a value (an integrated value) representing the amount of light of the pulsed light L1 in the period in which the pulsed light L1 is continuously radiated to the subject 50. In addition, the final count value of the operation processor 120 is output to the signal processing device 30 as a pixel signal.

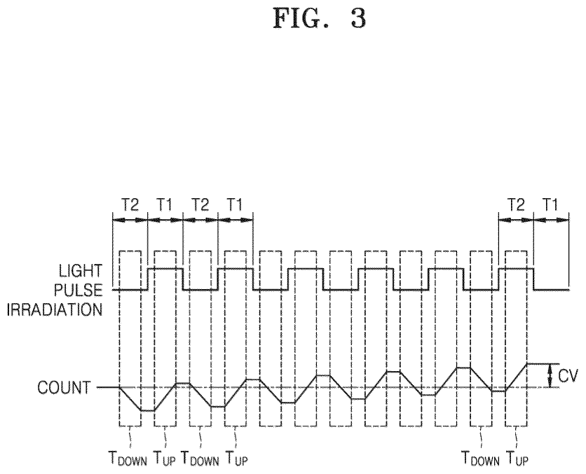

FIG. 3 is a timing diagram illustrating an example of an operation of the imaging system 1 according to an embodiment.

In FIG. 3, the upper portion of the timing diagram illustrates a light emission operation of the pulsed light L1 radiated from the light source device 10, and the lower portion of the timing diagram illustrates a change in count value of the operation processor 120. The period included in the rectangular dashed line area in FIG. 3 represents a count period in which the operation processor 120 up-counts or down-counts the pulse signal. The count period includes an up-count period Tup in which the operation processor 120 up-counts the pulse signal, and a down-count period TDOWN in which the operation processor 120 down-counts the pulse signal. When the period in which the pulsed light is turned on is the first period T1 and the period in which the pulsed light is turned off is the second period T2 during the flashing cycle of the pulsed light, the count period Tup and TDOWN is preferably set to be slightly shorter than the first period T1 and the second period T2 (to secure a margin of timing misalignment).

In the imaging system 1 of the present embodiment, while the pulsed light L1 flashing at a predetermined frequency is continuously radiated to the subject 50, the operation processor 120 performs processing for up-counting the pulse signal and processing for down-counting the pulse signal for each flashing cycle of the pulsed light.

More specifically, as illustrated in FIG. 3, in the first cycle of the flashing cycle of the pulsed light L1, the operation processor 120 first down-counts the pulse signal output from the photoelectric converter 110 in the second period T2 in which the pulsed light is turned off. Subsequently, in the first period T1 in which the pulsed light is turned on, the operation processor 120 up-counts the pulse signal output from the photoelectric converter 110.

Similarly, in the next cycle of the flashing cycle of the pulsed light L1, the operation processor 120 down-counts the pulse signal output from the photoelectric converter 110 in the second period T2 in which the pulsed light is turned off. Subsequently, in the first period T1 in which the pulsed light is turned on, the operation processor 120 up-counts the pulse signal output from the photoelectric converter 110.

In the period in which the pulsed light L1 is continuously radiated to the subject 50, the operation processor 120 repeatedly performs the above processing. The number of up-counted pulse signals is a value representing the amount of light including both the pulsed light component and the external light component, and the number of down-counted pulse signals is a value representing the amount of light including only the external light component.

Accordingly, as illustrated in the lower diagram of FIG. 3, the count value of the operation processor 120 slowly increases by the number of pulse signals corresponding to the amount of light of the pulsed light component while repeatedly increasing and decreasing with the lapse of time. The final count value (cumulative value) CV of the operation processor 120 is a value representing the amount of light including only the pulsed light component with the external light component removed, and may be output to the signal processing device 30 as a pixel signal of the pixel 100. The signal processing device 30 generates a captured image of the subject 50 from the pixel signals of the plurality of pixels 100.

As described above, in the imaging system 1 of the present embodiment, the amount of light of the pulsed light reflected by the subject 50 is detected while the external light component is removed for each flashing cycle of the pulsed light. Here, one flashing cycle of the pulsed light is shorter than a period (for example, one frame period) in which the captured image is generated. Therefore, although the subject 50 moves during one flashing cycle of the pulsed light, it may be difficult for artifacts to occur in the captured image because a plurality of on-periods and a plurality of off-periods of the pulsed light may be considered to almost overlap as a whole in one frame. Therefore, in the imaging system 1 according to the present embodiment, it is possible to suppress the occurrence of artifacts in the captured image and to remove the influence of the external light L2.

Furthermore, in the imaging system 1 according to the present embodiment, processing for removing the influence of the external light L2 is performed in the pixel 100 and within acquisition time of one frame image. Therefore, in the imaging system 1 according to the present embodiment, an image processing device performing differential processing of two captured images becomes unnecessary, thereby simplifying a system configuration.

In addition, in the imaging system 1 according to the present embodiment, photons of the pulsed light are detected by the SPAD 111. Therefore, in the imaging system 1 according to the present embodiment, detection precision of the pulsed light is improved compared to when a photodiode is used.

In addition, in the imaging system 1 according to the present embodiment, the processing for down-counting the pulse signal is performed before the processing for up-counting the pulse signal. According to such a configuration, a negative side of the up-down counter 130 (the operation processor 120) includes only the external light component, and both sides of the up-down counter 130 (the operation processor 120) include a range of the integrated value of the pulsed light component so that a counter size of the up-down counter 130 may be minimized. That is, when starting from an up-count (when radiated), the maximum count of the up-count is (the external light component+a reflected light component), but when starting from a down-count (when not radiated), the maximum of the down-count is (the external light component) and the maximum of the up-count is (the reflected light component) so that the counter size of the up-down counter 130 is determined as a component with a greater value between the external light component and the reflected light component. Therefore, starting from the down-count (when not radiated) may reduce the counter size.

In addition, the higher the frequency of the pulsed light L1, the less a time difference between the first period T1 and the second period T2, and the greater effect of preventing artifacts. When the high-frequency pulsed light L1 is used, a light receiving period (the first period T1 or the second period T2) becomes short so that the signal amount of the external light component decreases and the count value of the external light component decreases. Therefore, in the imaging system 1 according to the present embodiment, the higher the frequency of the pulsed light L1, the less the counter size of the up-down counter 130 (the operation processor 120).

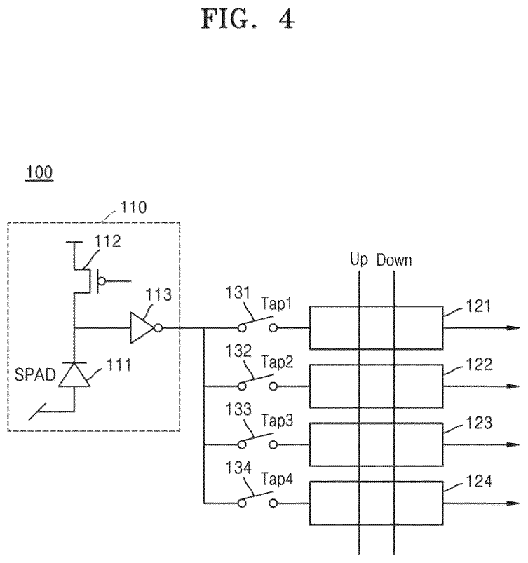

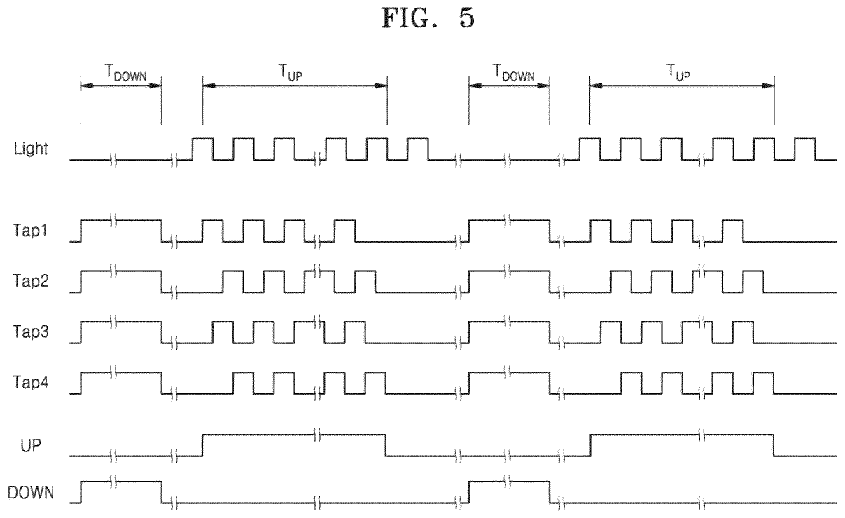

Another embodiment of the inventive concept will be described with reference to FIGS. 4 and 5 below. In the embodiment of FIGS. 4 and 5, the imaging system 1 is applied to an indirect Time of Flight (iToF) measuring system. In addition, the same reference numerals denote the same components as in the embodiment of FIGS. 2 and 3, and description thereof is omitted.

FIG. 4 is a circuit diagram illustrating a schematic configuration of a pixel 100 of an embodiment according to an embodiment.

The solid-state imaging device 20 of the present embodiment is a so-called multi-tap image sensor, and hereinafter, description will be given taking a case in which the pixel 100 has four taps as an example.

As illustrated in FIG. 4, the pixel 100 includes the photoelectric converter 110, first, second, third, and fourth operation processing units or operation processors 121, 122, 123, and 124, and first, second, third, and fourth switches 131, 132, 133, and 134. The photoelectric converter 110 is connected to the first to fourth operation processors 121 to 124 through the first to fourth switches 131 to 134, respectively.

The photoelectric converter 110 includes an SPAD 111 detecting photons. The first to fourth operation processors 121 to 124 are up-down counters up-counting or down-counting a pulse signal output from the photoelectric converter 110. The first to fourth switches 131 to 134 switch the first to fourth operation processors 121 to 124 connected to the photoelectric converter 110. The first to fourth operation processors 121 to 124 may correspond to first, second, third, and fourth taps Tap1, Tap2, Tap3, and Tap4, respectively.

In the imaging system 1 according to the present embodiment configured as described above, the pulsed light L1 is intermittently radiated from the light source device 10 to the subject 50. Because the present embodiment is applied to iToF measuring system, the pulsed light L1 flashes at a frequency of tens to hundreds of MHz. In the first period in which the pulsed light is radiated from the light source device 10 to the subject 50, the pulse signal output from the photoelectric converter 110 is up-counted. On the other hand, in the second period in which the radiation of the pulsed light to the subject 50 is stopped, the pulse signal output from the photoelectric converter 110 is down-counted. The first period in which the pulsed light is radiated and the second period in which the radiation of the pulsed light is stopped are repeated at a predetermined frequency (for example, 1 kHz to 10 kHz).

FIG. 5 is a timing diagram illustrating an example of an operation of the imaging system 1 according to an embodiment.

“Light” of FIG. 5 represents a driving signal of the light source device 10, “Tap1” to “Tap4” of FIG. 5 represent driving signals of the first to fourth switches 131 to 134, and each is driven with a phase difference of 90 degrees. “Up” of FIG. 5 represents a driving signal of an up-count operation of the first to fourth operation processors 121 to 124, and “Down” of FIG. 5 represents a driving signal of a down-count operation of the first to fourth operation processors 121 to 124. Although description is given based on four taps in FIG. 5 in the present embodiment, embodiments of the disclosure are not limited thereto, and the number of taps may be increased to achieve a fine phase difference according to an embodiment. For example, when the number of taps is n, the phase difference may be 360/n degrees.

In the imaging system 1 of the present embodiment, the first period in which the pulsed light is radiated to the subject 50 and the second period in which the radiation of the pulsed light to the subject 50 is stopped are periodically repeated in one frame period. The first to fourth operation processors 121 to 124 up-count the pulse signal in the first period and down-count the pulse signal in the second period.

More specifically, as illustrated in FIG. 5, first, in the second period in which the radiation of the pulsed light to the subject 50 is stopped, the first to fourth switches 131 to 134 are turned on, and the first to fourth operation processors 121 to 124 are connected to the photoelectric converter 110. At the same time, the down-count operation is turned on, and the first to fourth operation processors 121 to 124 down-count the pulse signal output from the photoelectric converter 110. The first to fourth operation processors 121 to 124 down-count the pulse signal in a predetermined down-count period TDOWN during the second period. As a result, the count value representing the amount of light including only the external light component is down-counted in the first to fourth operation processors 121 to 124.

Subsequently, in the first period in which the pulsed light is continuously radiated to the subject 50, the first switch 131, the third switch 133, the second switch 132, and the fourth switch 134 are each turned on with a phase difference of 90 degrees, and the first to fourth operation processors 121 to 124 are each connected to the photoelectric converter 110 with a phase difference of 90 degrees. During the period, the up-count operation is turned on, and the first to fourth operation processors 121 to 124 up-count the pulse signals output from the photoelectric converter 110 while the corresponding first to fourth switches 131 to 134 are turned on, respectively. During the first period, the operation of the first switch 131, the third switch 133, the second switch 132, and the fourth switch 134 being turned on in that order is repeated in synchronization with the flashing operation of the pulsed light L1. The first to fourth operation processors 121 to 124 repeatedly up-count the pulse signals in a predetermined up-count period Tup during the first period. As a result, as the pulse signals for light including the pulsed light component and the external light component are time-divided with a phase difference of 90 degrees, the count values representing the amount of light time-divided into four taps are up-counted in the first to fourth operation processors 121 to 124.

In a period (for example, one frame period) in which the pulsed light L1 is intermittently radiated to the subject 50, the operation processor 120 repeatedly performs the above processing. The number of up-counted pulse signals is a value representing the amount of light including both the pulsed light component and the external light component, and the number of down-counted pulse signals is a value representing the amount of light including only the external light component. The final count value of the first to fourth operation processors 121 to 124 is a value (an integrated value) representing the amount of light of only the pulsed light component in the period in which the pulsed light L1 is intermittently radiated to the subject 50 (that is, the external light component is removed). The final count value of the first to fourth operation processors 121 to 124 may be output to the signal processing device 30 as a pixel signal. The signal processing device 30 calculates a phase difference between the pulsed light radiated from the pixel signals of the four taps and received pulsed light, and calculates a distance from phase difference information to the subject 50 to generate a distance measurement image for the subject 50. Because technology of calculating a distance from pixel signals of four taps to a subject to generate a distance measurement image is well-known, detailed description thereof is omitted.

As described above, in the imaging system 1 according to the present embodiment, the external light component is removed in the period in which the pulsed light is intermittently radiated to the subject 50 so that the amount of light of the pulsed light reflected by the subject 50 is detected. Here, because the cycle in which the processing for up-counting the pulse signal and the processing for down-counting the pulse signal are performed is shorter than the period in which the distance measurement image is generated, it may be difficult for artifacts to occur in the distance measurement image although the subject 50 moves in the period in which the distance measurement image is generated. Therefore, in the imaging system 1 according to the present embodiment, it is possible to prevent artifacts from occurring in the distance measurement image and to remove the influence of the external light L2.

In a related art iToF distance measuring system using a photodiode, when performing the same external light removal, it is necessary to time-divide the output signal with a phase difference of 90 degrees in the period in which only the external light component is received considering charge bias between the taps. However, in the imaging system 1 according to the present embodiment, it is not necessary to consider charge bias because the pulse signal digitized by the photoelectric converter 110 is counted. Therefore, in the imaging system 1 according to the present embodiment, it is not necessary to time-divide the output signal in the period in which only the external light component is received, and the period in which only the external light component is received may be reduced by half compared to the related art iToF distance measuring system. Therefore, in the imaging system 1 according to the present embodiment, the second period (or the down-count period TDOWN) is reduced by half of the first period (or the up-count period TUP), and as a result, the total light receiving time may be reduced, thereby improving a frame rate.

In addition, in the imaging system 1 according to the present embodiment, the processing for down-counting the pulse signal is performed before the processing for up-counting the pulse signal. According to such a configuration, the counter size of the four up-down counters (the first to fourth operation processors 121 to 124) may be minimized.

Embodiments of the disclosure are not limited to the example embodiments described above, and may be modified into various embodiments within the scope of the claims.

For example, in the embodiments described above, a case was described in which pulse signals of the number corresponding to the number of photons are output as output signals of the photoelectric converter 110. However, in an embodiment, the output signals are not limited to the pulse signals of the number corresponding to the number of photons, but may be a voltage signal having a magnitude corresponding to the number of photons. In this case, the operation processor 120 performs processing for adding a voltage value in the first period and performs processing for subtracting the voltage value in the second period.

In addition, in the embodiments described above, the case in which the SPAD 111 is provided in the photoelectric converter 110 was described as an example. However, embodiments of the disclosure are not limited thereto, and a photodetector for detecting photons is not limited to an SPAD, and may be an avalanche photodiode (APD).

In addition, in the embodiments described above, it was described that the processing for down-counting the pulse signal was performed before the processing for up-counting the pulse signal. However, embodiments of the disclosure are not limited thereto, and the processing for up-counting the pulse signal may be performed before the processing for down-counting the pulse signal.

While certain example embodiments of the disclosure have been particularly shown and described, it will be understood that various changes in form and details may be made therein without departing from the spirit and scope of the following claims.

What is claimed is:

1. A solid-state imaging device comprising:
a plurality of pixels,
wherein each pixel of the plurality of pixels comprises:
a photoelectric converter configured to detect photons and to output a signal corresponding to a number of photons that are detected; and
at least one operation processor configured to add an output signal of the photoelectric converter for pulsed light and external light which are received by the pixel in a first period in one frame period, and to subtract the output signal of the photoelectric converter for the external light received by the pixel in a second period in the one frame period.

2. The solid-state imaging device of claim 1, wherein the photoelectric converter comprises a single photon avalanche diode (SPAD) and is further configured to output pulse signals of a number corresponding to the number of photons, and
wherein each of the at least one operation processor comprises an up-down counter configured to up-count the pulse signals in the first period and to down-count the pulse signals in the second period.

3. The solid-state imaging device of claim 1, wherein the first period is a period in which the pulsed light is turned on in a flashing cycle of the pulsed light, and the second period is a period in which the pulsed light is turned off during the flashing cycle of the pulsed light, and
wherein the at least one operation processor is further configured to perform processing for adding the output signal and processing for subtracting the output signal during the flashing cycle of the pulsed light.

4. The solid-state imaging device of claim 3, wherein the at least one operation processor is further configured to, in a period in which the pixel continuously receives the pulsed light, repeatedly perform processing for adding the output signal and processing for subtracting the output signal.

5. The solid-state imaging device of claim 1, wherein the at least one operation processor comprises a plurality of operation processors corresponding to a plurality of time-divided output signals of the photoelectric converter.

6. The solid-state imaging device of claim 5, wherein the first period is a period in which the pixel continuously receives the pulsed light, and the second period is a period in which the pixel does not receive the pulsed light, and
wherein each of the plurality of operation processors is configured to processing for adding an output signal of the plurality of time-divided output signals in the first period and processing for subtracting an output signal of the plurality of time-divided output signals in the second period.

7. The solid-state imaging device of claim 6, wherein the first period and the second period are periodically repeated in the one frame period, and
wherein each of the plurality of operation processors is further configured to repeatedly performs processing for adding the output signal and processing for subtracting the output signal in the one frame period.

8. The solid-state imaging device of claim 1, wherein the at least one operation processor is further configured to perform processing for subtracting the output signal before processing for adding the output signal.

9. An imaging system comprising:
a light source device configured to radiate pulsed light to a subject; and
a solid-state imaging device configured to receive the pulsed light reflected by the subject,
wherein the solid-state imaging device comprises a plurality of pixels, and
wherein each pixel of the plurality of pixels comprises:
a photoelectric converter configured to detect photons and to output a signal corresponding to a number of photons that are detected; and
at least one operation processor configured to add an output signal of the photoelectric converter for the pulsed light and external light which are received by the pixel in a first period in one frame period, and to subtract the output signal of the photoelectric converter for the external light received by the pixel in a second period in the one frame period.

10. The imaging system of claim 9, wherein the photoelectric converter comprises a single photon avalanche diode (SPAD) and is further configured to output pulse signals of a number corresponding to the number of photons, and
wherein each of the at least one operation processor comprises an up-down counter configured to up-count the pulse signals in the first period and to down-count the pulse signals in the second period.

11. The imaging system of claim 9, wherein the first period is a period in which the pulsed light is turned on in a flashing cycle of the pulsed light, and the second period is a period in which the pulsed light is turned off during the flashing cycle of the pulsed light, and wherein the at least one operation processor is further configured to perform processing for adding the output signal and processing for subtracting the output signal during the flashing cycle of the pulsed light.

12. The imaging system of claim 11, wherein the at least one operation processor is further configured to, in a period in which the light source device continuously radiates the pulsed light to the subject, repeatedly perform processing for adding the output signal and processing for subtracting the output signal.

13. The imaging system of claim 9, wherein the at least one operation processor comprises a plurality of operation processors corresponding to a plurality of time-divided output signals of the photoelectric converter.

14. The imaging system of claim 13, wherein the first period is a period in which the light source device continuously radiates the pulsed light to the subject, and the second period is a period in which the light source device stops radiating the pulsed light to the subject, and
wherein each of the plurality of operation processors is configured to perform processing for adding the output signal in the first period and processing for subtracting the output signal in the second period.

15. The imaging system of claim 14, wherein the first period and the second period are periodically repeated in the one frame period, and
wherein each of the plurality of operation processors is further configured to repeatedly perform processing for adding the output signal and processing for subtracting the output signal in the one frame period.

16. The imaging system of claim 9, wherein the at least one operation processor is further configured to perform processing for subtracting the output signal before processing for adding the output signal.

17. A solid-state imaging device comprising a plurality of pixels,
wherein each of the plurality of pixels comprises:
a photoelectric converter configured to detect photons and to output a pulse signal corresponding to the photons that are detected;
a first operation processor, a second operation processor, a third operation processor, and a fourth operation processor; and
a first switch, a second switch, a third switch, and a fourth switch which are configured to connect the first operation processor, the second operation processor, the third operation processor, and the fourth operation processor, respectively, to the photoelectric converter, and
wherein each of the first operation processor, the second operation processor, the third operation processor, and the fourth operation processor is configured to up-count the pulse signal output from the photoelectric converter in a first period in one frame period and down-count the pulse signal output from the photoelectric converter in a second period in the one frame period.

18. The solid-state imaging device of claim 17, wherein the first period is a period in which pulsed light is continuously radiated to a subject, and
wherein the second period is a period in which irradiation of the pulsed light to the subject is stopped.

19. The solid-state imaging device of claim 17, wherein a number of up-counted pulse signals represents an amount of light including a pulsed light component and an external light component, and
wherein a number of down-counted pulse signals represents an amount of light including the external light component.

20. The solid-state imaging device of claim 17, wherein a final count value of the first operation processor, the second operation processor, the third operation processor, and the fourth operation processor represents an amount of light including a pulsed light component from which an external light component is removed in a period in which pulsed light is intermittently radiated to a subject.
